(19) United States
(12) Patent Application Publication
(10) Pub. No.: US 2010/0007247 A1
(43) Pub. Date: Jan. 14, 2010

(54) FIELD DEVICE OF A PROCESS AUTOMATION INSTALLATION HAVING A DEVICE FOR LOCALLY OBTAINING ELECTRICAL ENERGY

(75) Inventor: Stefan Tabelander, Herford (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/501,865

(22) Filed: Jul. 13, 2009

(30) Foreign Application Priority Data
Jul. 14, 2008 (DE) 10 2008 033 048.5

(51) Int. Cl. H02N 2/00

(52) U.S. Cl. 310/339

(57) ABSTRACT

A field device of a process automation installation is provided. The filed device includes an electrical connection configured to be connected to a superordinate control unit, a fluidic pressure connection configured to supply an operating pressure as an auxiliary energy, and a means for local feeding with electrical energy integrated into the field device. The means for local feeding with electrical energy includes a fluidic operating voltage production unit, which includes a piezo-element arrangement having at least part of the operating pressure is applied thereto to produce the electrical energy for the local feed.

### RELATED APPLICATION

This application claims priority under 35 U.S.C. §119 to German Patent Application No. 10 2008 033 048.5 filed in Germany on Jul. 14, 2008, the entire content of which is hereby incorporated by reference in its entirety.

### FIELD

The present disclosure relates to a field device of a process automation installation, which has an electrical connection for connection to a superordinate control unit, a fluidic pressure connection for supply with an operating pressure as auxiliary energy, and means for local feeding with electrical energy being integrated into the field device.

The present disclosure encompasses field devices which can be operated by a pressure means, for example electro-pneumatic position regulators which have direct or indirect access to preferably pneumatic auxiliary energy, which the position regulator uses for drive purposes. The term “field device” means a device which can be arranged decentralized in the field, that is to say in a process automation installation in the vicinity of the process to be controlled, and which can carry out functions relating to the detection of process variables and/or influencing of the process. Devices such as these are also referred to as a measurement transmitter, an actuating element or actuators. They may have devices for connection to a network and use communication standards from automation technology for communication purposes. Examples of communication standards such as these are CAN, HART, PROFIBUS or those based on ETHERNET, PROFINET, IP or the like.

### BACKGROUND INFORMATION

Field devices, in particular 4-20 mA devices, as well as those with a fieldbus, which are supplied with energy from a connected bus line, have a limited amount of available electrical energy. The devices comply with increasingly stringent requirements relating to electrical energy consumption. This is because new functional modules to be integrated in field devices, such as data radio modules, require additional electrical energy. Background lighting of the indication display of a field device or the electromagnet of a proportional valve, which is used as a control valve and operates the booster stage of the valve without any pilot control pressure, also pose difficult constraints in complying with required energy supply.

DE 10 2006 009 979 A1 proposes a technical solution which includes an energy management unit for an increased energy demand in the case of a field device. In this case, the increased energy demand is caused by an integrated radio module which is used to convert cable-based communication to wire-free (wireless) communication. In order to minimize the energy consumption and therefore to lengthen the life of an energy store that is integrated in the field device, the energy management unit switches the radio module off when there is no need for wire-free communication. The radio module is switched on only at predetermined operating times, which means that wire-free communication can be carried out with increased operating energy.

However, this solution has the disadvantage that usefulness of the radio module is governed by the available energy, and thus is not oriented to a demand for wire-free communication. The radio module is therefore not available without restrictions, and there is still a risk of the energy store being discharged, thus leading to malfunctions. Furthermore, the implementation of an energy management unit together with an energy store in a field device necessitates quite a high level of hardware complexity.

DE 10 2004 009 734 A1 proposes an alternative solution for local feeding of electrical energy in the case of a field device, which is not restricted to the electrical energy supplied via a bus line. Light energy received via an optical waveguide is used for the local energy supply, and the received light energy is converted to electrical energy. The optical waveguide is intended primarily for data transmission between a field device and a superordinate control, and its function with respect to the energy supply is upgraded. However, this technical solution requires quite a large amount of light energy transmission over a sufficiently long period to the field device. Furthermore, this solution is suitable only for field devices equipped with an optical waveguide connection.

DE 2002 38 65 U1 proposes a field device which includes evaluation electronics and a communication unit with a specific connecting unit which can be connected to an additional voltage supply unit. The voltage supply unit may be in the form of a battery and is therefore subject to the above-mentioned disadvantages of a local energy feed by means of an energy store. In addition, it is also proposed that this additional voltage supply unit be fitted with solar cells, a Peltier element, radio energy conversion or a vibration energy transducer. The choice of these means for local feeding with electrical energy depends on the type of environmental energy available. In principle, electrical energy is, in this case, obtained from the environment. Furthermore, in the case of the proposed vibration energy transducer, for example, it is necessary to ensure that the field device is subject to sufficiently strong oscillation during operation in order to obtain an adequate amount of electrical energy.

### SUMMARY

A field device is provided according to at least one exemplary embodiment. The exemplary field device comprises an electrical connection configured to be connected to a superordinate control unit. The exemplary field device also comprises a fluidic pressure connection configured to supply an operating pressure as auxiliary energy, and means for local feeding with electrical energy integrated within the field device. The means for local feeding with electrical energy comprises a fluidic operating voltage production unit. According to an exemplary embodiment, the fluidic operating voltage production unit comprises a piezo-element arrangement which is configured to have at least part of the operating pressure applied thereto, and which is configured to produce the electrical energy for local feeding from the at least part of the operating pressure applied thereto.

### BRIEF DESCRIPTION OF THE DRAWINGS

Further advantages and refinements of the present disclosure are explained in more detail below with reference to exemplary embodiments which are illustrated in the attached drawing, in which:

FIG. 1 is a block diagram illustrating an exemplary field device having means for local feeding with electrical energy.

### DETAILED DESCRIPTION

Exemplary embodiments of the present disclosure provide a field device having means for local feeding of electrical energy, which are of technically simple design and ensure a reliable electrical energy supply.

Exemplary embodiments of the present disclosure provide that the means for local feeding with electrical energy can comprise a fluidic operating voltage production unit, which has a piezo-element arrangement. At least part of an operating pressure can be applied to the piezo-element arrangement, which uses the operating pressure applied thereto to produce the electrical energy for the local feed.

An advantageous aspect of exemplary embodiments of the present disclosure is that the electrical energy is not produced from the environment but directly from an energy source for supplying the field device, which is also permanently available. The electrical energy can therefore also be produced permanently from this and the demand for energy can always be satisfied. In this case, the energy source can have a pressure means with quite a high energy density, and the electrical energy can resultantly be produced directly, by virtue of the piezo-effect, with a fluidic operating voltage supply unit having a reduced technical complexity. It is known that piezo-elements convert a mechanical pressure to an electrical voltage.

In the case of a process automation installation, such as for a positioning use, for example, pressure means can be available for supplying the field device with pneumatic energy, for example. Compressed air can be made available, for example, although natural gas or some other pneumatic medium may also be available as the pressure means. In the case of positioners, such as electro-pneumatic actuating regulators,for example,a portion of the compressed air can be tapped off to form a control pressure circuit for pilot control which is used as a supply for pneumatic auxiliary energy. According to an exemplary embodiment, the control air can provide energy for ventilation, closing or venting of a downstream pneumatic amplifier, a booster stage, which is not available in the form of electrical energy. This pneumatic auxiliary energy can also be used for application to the piezo-element arrangement to obtain electrical energy, without involving any significant design modifications to the field device.

According to an exemplary embodiment, the piezo-element arrangement can be in the form of a piezoelectric planar transducer which can oscillate and be mounted in a sprung manner. This is because a planar transducer, for example, can allow electrical energy to be obtained particularly efficiently on the basis of the piezo-effect. A planar transducer can comprise a piezo-ceramic film which is covered with a conductive material on both sides in order to make electrical contact. This structure can then be embedded in a flexible polymer composite material. The piezo-ceramic can therefore be electrically insulated, mechanically prestressed, and the intrinsically brittle material can be made more robust to also withstand application of pressure means.

Since, oscillation of a planar transducer can produce electrical energy which can be used for feeding energy, an advantageous aspect of the present disclosure provides that an alternating operating pressure can act on the piezo-element arrangement to produce an AC voltage, which corresponds to the alternation frequency, or a pulsating DC voltage.

According to an exemplary embodiment, a mechanical vibration arrangement can advantageously convert the permanent pressure taken from the fluidic pressure connection to an alternating operating pressure, so as to produce an alternating operating pressure. According to this exemplary configuration, the permanent pressure can be chopped to the atmosphere by changeable dissipation, so as to produce a mechanical oscillation which is passed to the piezo-element arrangement. The mechanical vibration arrangement does not require auxiliary energy and can set itself to an appropriate oscillation frequency for the operating pressure. In an exemplary configuration, the mechanical vibration arrangement can be in the form of a tube bearing which can oscillate and through which the operating pressure can flow in a turbulent manner.

Another advantageous aspect of at least one exemplary embodiment provides that the piezo-element arrangement can be followed by a rectifier means for rectification and/or smoothing of the AC voltage or pulsating DC voltage which is produced. By way of example, a diode bridge circuit, which is known, in combination with a smoothing capacitor can be effective for this purpose.

According to an exemplary embodiment, the operating voltage production unit can be connected to a rechargeable battery unit, if appropriate. In this case, the rechargeable battery unit can be effective for temporary buffering of electrical energy that is produced to ensure that the buffered electrical energy is available for at least a certain amount of time in the event of a malfunction, so that the field device remains controllable despite a failure of another energy source, such as the operating pressure, for example, so as to carry out a defined emergency shutdown, for example.

According to an exemplary embodiment, in addition to or instead of a rechargeable battery unit, electrical energy can fed via the electrical connection, such as by means of a two-conductor bus line of a data bus or the like, for example. To maintain the advantage of the autonomous local energy supply of the solution according to exemplary embodiments of the present disclosure, additional wiring can, however, be dispensed with.

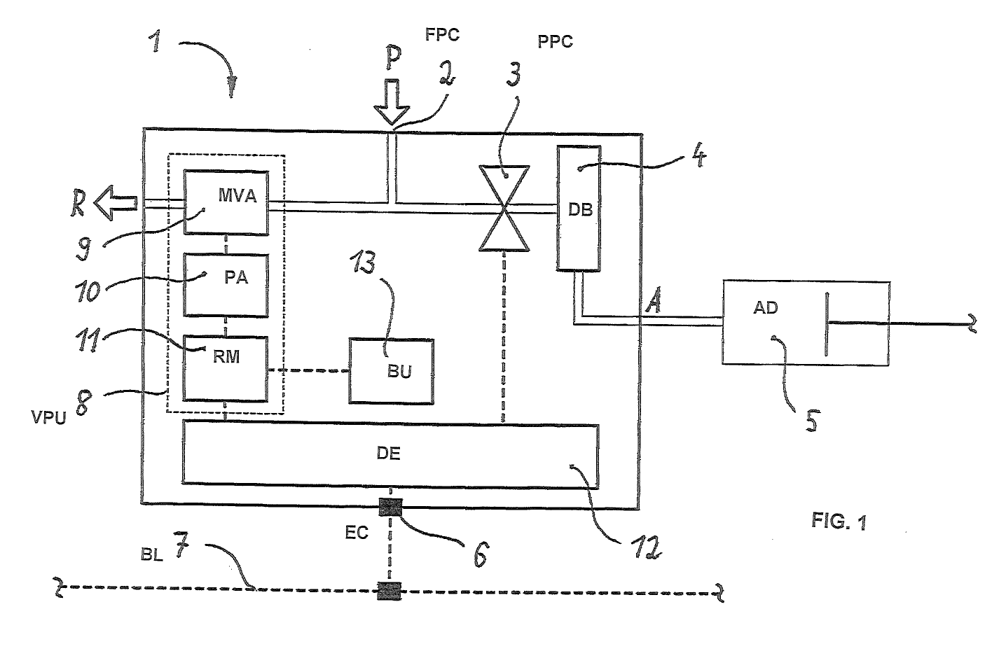

Further advantages, refinements and constitute features of the present disclosure will be described in more detail below with reference to an exemplary embodiment of the present disclosureillustrated in the drawing. FIG. 1 shows a schematic block diagram arrangement of an exemplary field device having means for local feeding with electrical energy.

According to an exemplary embodiment illustrated in FIG. 1, a field device I is provided which acts as an electro-pneumatic actuating regulator. In the exemplary field device 1, compressed air is cut off from a fluidic pressure connection (FPC) 2 in order to supply a pneumatic pilot control stage (PPC) 3 and a downstream booster stage (DB) 4, whose operating pressure is used for application of an actuating drive (AD) 5 for operation of a fitting connected to the actuating drive.

The electrical drive for the pilot control stage 3 is provided from an electrical connection (EC) 6 of the field device 1. The field device 1 is connected to a two-conductor bus line (BL) 7 of a data bus at the electrical connection.

As means for local feeding of electrical energy to the field device 1, the field device 1 also includes a fluidic operating voltage production unit (VPU) 8, which comprises a mechanical vibration arrangement (MVA) 9 with a downstream piezo-element arrangement (PA) 10. An input side of the mechanical vibration arrangement 9 is connected to the fluidic pressure connection 2. The mechanical vibration arrangement 9 produces an alternating operating pressure originating from the fluidic pressure connection 2. According to an exemplary configuration, the pressure can be constant and subject only to minor fluctuations, in which case an alternating operating pressure results in force being applied to the downstream piezo-element arrangement 10.

The piezo-element arrangement 10 can be provided in the form of a piezo-electric planar transducer which can pivot and which can be mounted in a sprung manner, for example. The piezo-element arrangement 10 uses the alternating operating pressure acting on it to produce a corresponding pulsating DC voltage, which is smoothed by downstream rectifier means (RM) 11 in order to subsequently make this DC voltage available as an operating voltage for drive electronics(DE) 12 which can likewise be integrated in the field device 1. Furthermore, the operating voltage production unit 8 can interact with a rechargeable battery unit (BV) 13, which can buffer the electrical energy produced by the operating voltage production unit 8 to ensure a reliable energy supply even in the event of a feed pressure failure. In addition, according to an exemplary embodiment the local operating voltage production technique can be assisted by an optional energy supply, which can be provided via the two-conductor bus line 7, for example.

The present disclosure is not restricted to the exemplary embodiments described above. Modifications would be feasible to those skilled in the art and are encompassed by the scope of the claimed invention. For example, it is also possible to dispense with a separate mechanical vibration arrangement 9, in which case the piezo-electric planar transducer can be arranged as a piezo-element arrangement 10 directly in the flow of the pressure means, which can result in the planar transducer carrying out an oscillating movement.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### List of Reference Symbols

1 Field device
2 Pressure connection
3 Pilot control stage
4 Booster stage
5 Actuating drive
6 Electrical connection
7 Two-conductor bus line
8 Operating voltage production unit
9 Vibration arrangement
10 Piezo-element arrangement
11 Rectifier means
12 Drive electronics
13 Rechargeable battery unit

What is claimed is:

1. A field device comprising:
an electrical connection configured to be connected to a superordinate control unit;
a fluidic pressure connection configured to supply an operating pressure as auxiliary energy; and
means for local feeding with electrical energy integrated within the field device,
wherein the means for local feeding with electrical energy comprises a fluidic operating voltage production unit, and
wherein the fluidic operating voltage production unit comprises a piezo-element arrangement which is configured to have at least part of the operating pressure applied thereto, and which is configured to produce the electrical energy for local feeding from the at least part of the operating pressure applied thereto.

2. The field device as claimed in claim 1,
wherein the piezo-element arrangement comprises a piezoelectric planar transducer which is configured to oscillate and be mounted in a sprung manner.

3. The field device as claimed in claim 1,
wherein the piezo-element arrangement is configured to, upon having an alternating operating pressure applied thereto, produce one of an AC voltage, which corresponds to an alternation frequency of the alternating operating pressure, and a pulsating DC voltage.

4. The field device as claimed in claim 3,
comprising a mechanical vibration arrangement configured to convert the operating pressure from the fluidic pressure connection into an alternating operating pressure, to produce the alternating operating pressure.

5. The field device as claimed in claim 4,
wherein the vibration arrangement comprises a tube which is configured to oscillate and which is arranged so that the operating pressure flows therethrough in a turbulent manner.

6. The field device as claimed in claim 1,
comprising rectifier means for at least one of rectification and smoothing of the AC voltage or pulsating DC voltage which is produced by the piezo-element arrangement.

7. The field device as claimed in claim 1,
wherein the operating voltage production unit is connected to a rechargeable battery unit, and is configured to buffer the produced electrical energy in the rechargeable battery unit.

8. The field device as claimed in claim 1,
comprising a two-conductor bus line of a data bus configured to receive electrical energy, in addition to the local feed with electrical energy.

9. The field device as claimed in claim 1,
wherein the field device is configured to be arranged in a process automation installation, and the field device is in the form of an electro-pneumatic actuating regulator configured to operate a fitting of the process automation installation.

10. The field device as claimed in claim 9,
wherein the field device is configured to operate as an electro-pneumatic actuating regulator to tap off compressed air from the fluidic pressure connection, and to act on the piezo-element arrangement so as to additionally form a control pressure circuit of a pneumatic pilot control stage for a downstream booster stage, which is configured to switch a flow of the compressed air to an actuating drive.

11. The field device as claimed in claim 2,
wherein the piezo-element arrangement is configured to, upon having an alternating operating pressure applied thereto, produce one of an AC voltage, which corresponds to an alternation frequency of the alternating operating pressure, and a pulsating DC voltage.

12. The field device as claimed in claim 11,
comprising a mechanical vibration arrangement configured to convert the operating pressure from the fluidic pressure connection into an alternating operating pressure, to produce the alternating operating pressure.

13. The field device as claimed in claim 12,
wherein the vibration arrangement comprises a tube which is configured to oscillate and which is arranged so that the operating pressure flows therethrough in a turbulent manner.

14. The field device as claimed in claim 3,
comprising rectifier means for at least one of rectification and smoothing of the AC voltage or pulsating DC voltage which is produced by the piezo-element arrangement.
